(19) United States
(12) Patent Application Publication
(10) Pub. No.: US 2017/0072429 A1
(43) Pub. Date: Mar. 16, 2017

(54) SELECTIVE WALL SEALING SYSTEM

(71) Applicant: James Larson, Leesburg, VA (US)

(72) Inventor: James Larson, Leesburg, VA (US)

(21) Appl. No.: 14/850,173

(22) Filed: Sep. 10, 2015

(51) Int. Cl. B05C 21/00

(52) U.S. Cl. CPC B05C 21/005

(57) ABSTRACT

A selective wall sealing system disclosed herein comprises a wall and a sealing member. The wall comprises one or more portions for utility elements, and the sealing member is configured to seal and secure the portions of utility elements from external contact when the maintenance activity is performed on the wall. In an embodiment, an adhesive is applied along the contour of the portion of the utility element, and the section of the sealing member outside the contour is cut away to allow a user to perform maintenance activity on the rest of the wall. In an embodiment, the sealing member is peeled off after the maintenance activity is performed on the wall. In an embodiment, the utility element is an electrical utility. In an embodiment, the sealing member is a sheet member. In an embodiment, the sealing member is made of paper, plastic, cardboard or posterboard.

### BACKGROUND

Walls and other similar surfaces normally comprise one or more electrical units, such as switches and outlets that are attached on a junction box which is secured to the fasteners of a wall or other similar surface. The inner portion of the junction box is uncovered by an opening on the wall, and in most cases, a covering plate is used to enclose the switch or outlet and the opening into the junction box. The covering plate offers a finished look while providing admittance to the device, such as a screw driver for operating the switch or sockets for receiving a plug. The covering plate generally covers a section of the wall which requires to be painted or finished, and is normally removed by the maintenance workers prior to painting task. However, this leaves the electrical device unprotected to damage caused by a lack in proper attention while working proximal to the electrical device, such as, a damage caused by paint sprayed inside the electrical device or wiring, a screw driver accidently contacting and damaging the body of the electrical device, etc.

It is known in the art to apply an impermanent paint protection to the electrical device or the electrical outlet to shield it from damage caused by accidents during maintenance procedures. The impermanent paint protection methods comprise, for example, the electrical box being hand taped or shut with brown paper/blue tape However, prior art paint protections suffer generally from a deficiency of stability when mounted to the junction box. Therefore, the electrical sections can be easily tampered with and therefore exposing the electrical device for possible damage or requiring the painter to shift focus on to the paint protection portion during painting which is time consuming and undesirable. Further, some paint protection members fit improperly around the contour of the junction box and therefore cannot be placed against the wall around the junction box, allowing accidents such as, paint runs, paint drips, paint splashes and spillage of paint onto the junction box behind the paint protection member and extent the electrical device. This is not a model or a template in use for application of drywall. In many cases the drywall is roughly finished and needs additional repairs once the cover plate is put back in place. Therefore, there is a need for enhancements in the technical area where painting or other similar maintenance activity being performed on a wall.

Hence, there is a long felt but unresolved need for a selective wall sealing system to efficiently perform maintenance activities on a wall without damaging any utility sections, such as electrical units positioned on the wall.

### SUMMARY OF THE INVENTION

The selective wall sealing system disclosed herein addresses the above stated needs for efficiently performing maintenance activities on a wall without damaging any utility sections, such as electrical units positioned on the wall, and providing a template to highlight any drywall imperfection made by installer during installation. The template will highlight any repairs needed prior to painting. The selective wall sealing system disclosed herein comprises a wall and a sealing member. The wall comprises one or more portions for utility elements, and the sealing member is attached over the portions of the utility elements to seal and secure the portions of utility elements from external contact when the maintenance activity is performed on the wall. In an embodiment, an adhesive is applied along the contour of the portion of the utility element, and the section of the sealing member outside the contour is cut away to allow a user to perform maintenance activity on the rest of the wall.

In an embodiment, the sealing member is a sheet member. In an embodiment, the sealing member is made of paper, plastic, cardboard or posterboard. In an embodiment, the sealing member is peeled off after the maintenance activity is performed on the wall. In an embodiment, the utility element is an electrical utility.

### BRIEF DESCRIPTION OF THE DRAWINGS

FIG. 1A exemplarily illustrates a front perspective view of the wall containing the selective wall sealing system.

FIG. 1B exemplarily illustrates a front perspective view of an enlarged view of the portion marked A in FIG. 1A, showing the sealing member being peeled off from the the utility element, for example, an electrical junction box.

FIG. 1C exemplarily illustrates a front perspective view of the selective wall sealing system, showing the electrical junction box after peeling off the sealing member.

FIG. 1D exemplarily illustrates a cutaway view of the selective wall sealing system with respect to FIG. 1C, showing a cap enclosing the electrical junction box.

FIG. 1E exemplarily illustrates a front perspective view of the selective wall sealing system, showing the cap enclosing the electrical junction box.

### DETAILED DESCRIPTION OF THE INVENTION

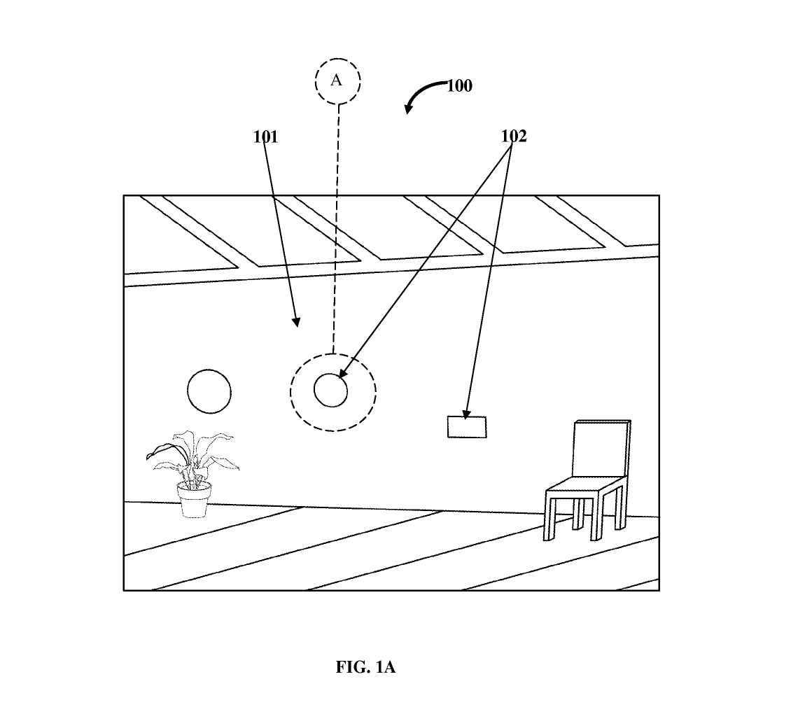

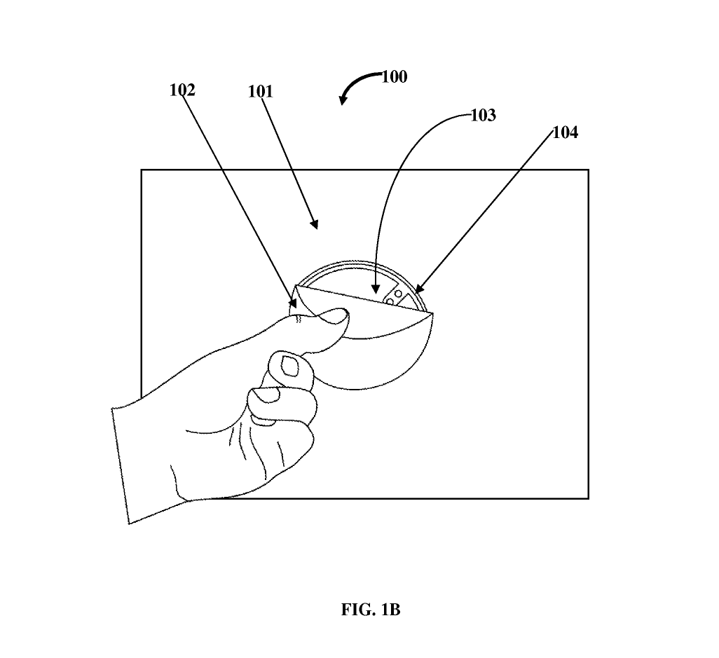

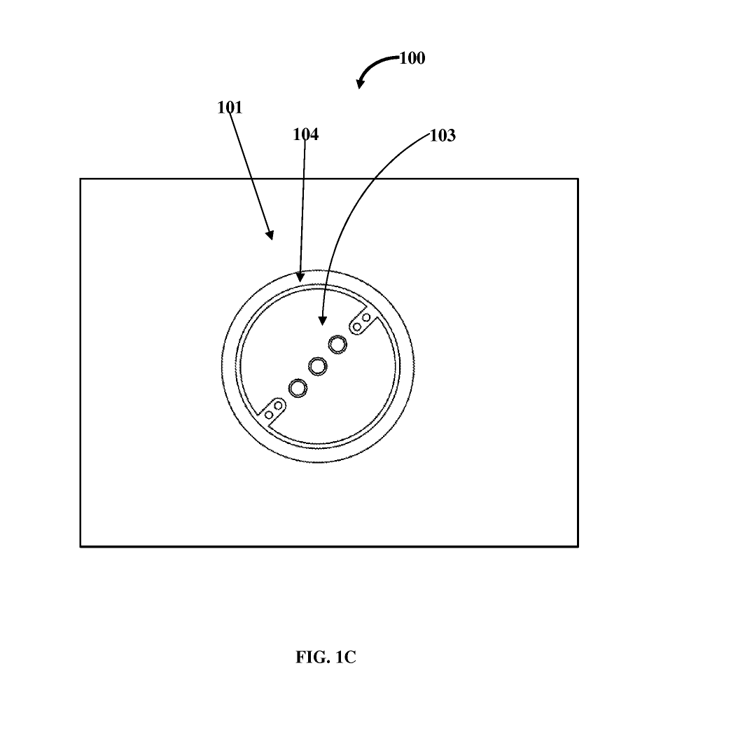

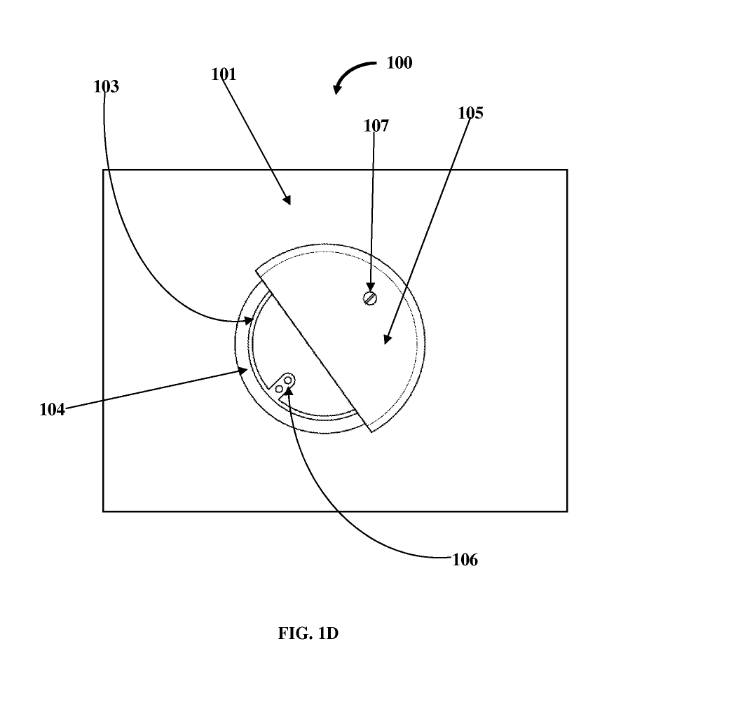

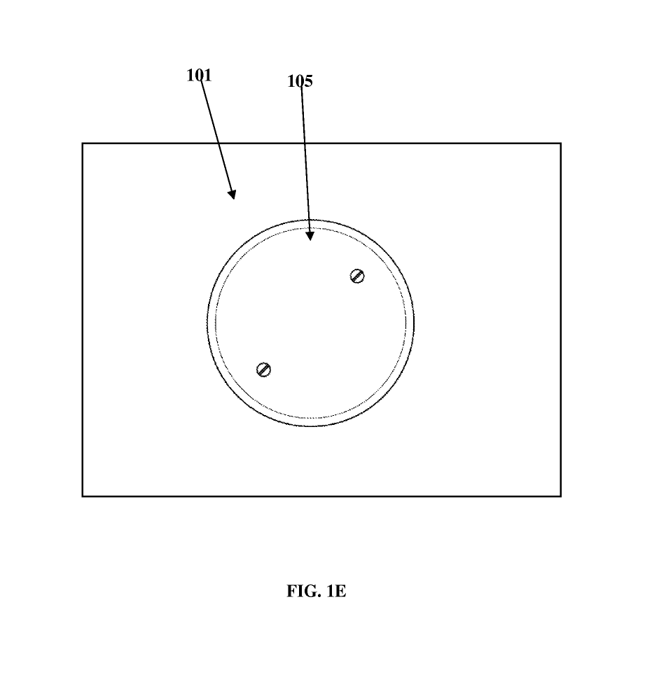

FIGS. 1A-1E exemplarily illustrates structure and working of the selective wall sealing system 100, where FIG. 1A exemplarily illustrates a front perspective view of the wall containing the selective wall sealing system 100, FIG. 1B exemplarily illustrates a front perspective view of an enlarged view of the portion marked A in FIG. 1A, showing the sealing member 102 being peeled off from the utility element 103, for example, an electrical junction box, FIG. 1C exemplarily illustrates a front perspective view of the selective wall sealing system 100, showing the electrical junction box 103 after peeling off the sealing member 102, FIG. 1D exemplarily illustrates a cutaway view of the selective wall sealing system 100 with respect to FIG. 1C, showing a cap 105 enclosing the electrical junction box 103, and FIG. 1E exemplarily illustrates a front perspective view of the selective wall sealing system 100, showing the cap 105 enclosing the electrical junction box 103.

The wall 101 is, for example, a drywall. As used herein, the term “drywall” refers to, for example, also known as plasterboard, wallboard, gypsum board, is a panel made of gypsum plaster pressed between two thick sheets of paper. Drywalls are is used to make interior walls and ceilings. One or more types of utility elements 103, especially electrical outlets are positioned on such drywalls. The maintenance of such drywalls is a difficult procedure and a lot of care has to be taken to perform the maintenance without damaging the electrical outlets. A proper sealing method or system, and a proper installation at initial application is needed to prevent such accidental damages. The selective wall sealing system 100 disclosed herein comprises a wall 101 and a sealing member 102. As shown in FIGS. 1A and 1B, the wall 101 comprises one or more portions for utility elements 103, and the sealing member 102 is attached over the portions of the utility elements 103, for example, the electrical junction box 103, to seal and secure the portions of utility elements 103 from external contact when the maintenance activity is performed on the wall 101. In an embodiment, the sealing member 102 is, for example, a sheet member as shown in FIG. 1B.

As exemplarily illustrated in FIG. 1B, in an embodiment, an adhesive 104 is applied along the contour of the portion of the utility element 103, and the section of the sealing member 102 outside the contour of the utility element 103 is cut away to allow a user to perform maintenance activity on the rest of the wall 101. For example, the glue or adhesive 104 is applied around the contour of the electrical junction box 103 and the sealing member 102 positioned over the electrical junction box 103. The sealing member 102 is pressed against the adhesive 104 so that the sealing member 102 securely covers the complete exposed surface of the electrical junction box 103. In an embodiment, the sealing member 102 is peeled off after the maintenance activity is performed on the wall 101 as shown in FIG. 1B. In an embodiment, the utility element 103 is, for example, an electrical utility. In an embodiment, the sealing member 102 is, for example, made of paper, plastic, cardboard or poster board.

The selective wall sealing system 100 further prevents dust and other particulates from entering and contacting the wires inside electrical boxes and recess cans. In an embodiment, the selective wall sealing system 100 provides a template for initial installation of drywall and drywall edges to fit behind the sealing member 102 or the cover plate. The selective wall sealing system 100 further facilitates cost savings by reducing the effort required to safeguard the utility elements 103 by other means, and reduces the net time required to finish the maintenance work as the template allows a finished edge that is hidden behind a sealing member 102 or a cover plate. Recess cans are required to be removed or replaced if any paint of other such particulate matter is found inside them so it's essential to cover such utility elements 103 via the selective wall sealing system 100. In an embodiment, guide tabs 106 are connected to the selective wall sealing system 100 to ensure that the selective wall sealing system 100 is centered on the junction boxes 103 and recess cans via fasteners 107 inserted through the sealing member 102 and the guide tabs 106, as shown in FIG. 1D.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A selective wall sealing system during a maintenance activity on a wall, comprising:
a wall comprising one or more portions for utility elements; and
a sealing member attached over the portions of the utility elements, the sealing member configured to seal and secure the portions of utility elements from external contact when the maintenance activity is performed on the wall.

2. The selective wall sealing system of claim 1, wherein an adhesive is applied along the contour of the portion of the utility element, and the section of the sealing member outside the contour is cut away to allow a user to perform maintenance activity on the rest of the wall.

3. The selective wall sealing system of claim 1, wherein the sealing member is a sheet member.

4. The selective wall sealing system of claim 1, provides a template for initial installation of drywall and drywall edges to fit behind the sealing member.

5. The selective wall sealing system of claim 1, wherein the sealing member is made of one of paper, plastic, cardboard and posterboard.

6. The selective wall sealing system of claim 1, wherein the sealing member is peeled off after the maintenance activity is performed on the wall.

7. The selective wall sealing system of claim 1, wherein the utility element is an electrical utility.
